(19) United States
(12) Patent Application Publication
(10) Pub. No.: US 2009/0162713 A1
(43) Pub. Date: Jun. 25, 2009

(54) STACK FOR FUEL CELL AND BIPOLAR PLATE AND COOLING PLATE ADOPTED IN THE SAME

(75) Inventors: Jie PENG, Yongin-si (KR); Jae-Young Shin, Yongin-si (KR); Seung-Jae Lee, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/047,627

(22) Filed: Mar. 13, 2008

(30) Foreign Application Priority Data
Dec. 24, 2007 (KR) 2007-136470

(51) Int. Cl. H01M 8/02; F28D 15/00

(52) U.S. Cl. 429/26; 429/34; 165/104.11

(57) ABSTRACT

Provided is a stack of a fuel cell in which a plurality of unit cells are stacked to perform an electricity generation reaction. The stack includes a membrane electrode assembly in which an anode, an electricity membrane, and a cathode are stacked; a bipolar plate having reactant channels through which fluids to be supplied to the anode and the cathode flow and a plurality of inner manifolds that are formed in positions not directly connected to the reactant channels so that a coolant pass through; and a cooling plate having a coolant channels through which a coolant flows and a plurality of inner manifolds that are formed corresponding to the inner manifolds of the bipolar plate so that the coolant pass through.

### CROSS-REFERENCE TO RELATED APPLICATIONS

This application claims the benefit of Korean Application No. 2007-136470, filed Dec. 24, 2007, in the Korean Intellectual Property Office, the disclosure of which is incorporated herein by reference.

### BACKGROUND OF THE INVENTION

1. Field of the Invention

The present invention relates to a stack in which a plurality of unit cells are stacked to generate an electricity generation reaction and bipolar plates and cooling plates installed in the stack.

2. Description of the Related Art

A fuel cell is an electric generator that changes chemical energy of a fuel into electrical energy through a chemical reaction, and the fuel cell can continuously generate electricity as long as the fuel is supplied. That is, when air that includes oxygen is supplied to a cathode, and hydrogen gas which is a fuel is supplied to an anode, electricity is generated by a reverse reaction of water electrolysis through an electrolyte membrane. However, generally, the electricity generated by a unit cell does not have a high voltage to be used. Therefore, electricity is generated by a stack in which a plurality of unit cells are connected in series.

During an electrochemical reaction, not only electricity but also heat is generated. Thus, in order to smooth operation of a fuel cell, the heat must be removed. Therefore, in order for the stack to smoothly operate, there is a need a structure that can readily cool a reaction heat while smooth supplying of a fuel and oxygen to the anode and the cathode.

### SUMMARY OF THE INVENTION

Aspects of the present invention provide a stack of a fuel cell, in which a bipolar plate and a cooling plate have a plurality of inner manifolds to channel fluids and/or coolant.

According to an aspect of the present invention, there is provided a stack of a fuel cell comprising: a membrane electrode assembly in which an anode, an electricity membrane, and a cathode are stacked; a bipolar plate having reactant channels through which fluids to be supplied to the anode and the cathode flow and a plurality of inner manifolds that are formed in positions not directly connected to the reactant channels so that a coolant pass through; and a cooling plate having a coolant channels through which a coolant flows and a plurality of inner manifolds that are formed corresponding to the inner manifolds of the bipolar plate so that the coolant pass through.

According to an aspect of the present invention, the reactant channels of the bipolar plate and the coolant channels of the cooling plate may be respectively formed in central regions of a main body of the bipolar plate and the cooling plate, and the inner manifolds of the bipolar plate and the inner manifolds of the cooling plate respectively may be formed on edges of the main body of the bipolar plate and the cooling plate.

According to an aspect of the present invention, the membrane electrode assembly may contact the reactant channels, however, may not contact the inner manifolds.

According to an aspect of the present invention, the bipolar plate may comprise a fuel supply manifold and a fuel return manifold, which are connected to the reactant channels, and the cooling plate may comprise a coolant supply manifold and a coolant return manifold, which are connected to the coolant channels.

According to an aspect of the present invention, there is provided a bipolar plate comprising: a reactant channels through which fluid flow; and a plurality of inner manifolds formed in positions of the bipolar plate adjacent to the reactant channels and not to be directly connected to the reactant channels so that the coolant flow through.

According to an aspect of the present invention, the reactant channels may be formed in a central region of a main body of the bipolar plate, and the inner manifolds may be formed in edges of the bipolar plate.

According to an aspect of the present invention, the bipolar plate may further comprise a fuel supply manifold and a fuel return manifold, which are directly connected to the reactant channels to constitute a path for entering and leaving fuel.

According to an aspect of the present invention, there is provided a cooling plate comprising: a coolant channels through which a coolant flows; a coolant supply manifold and a coolant return manifold which are directly connected to the coolant channels to constitute a path for entering and leaving the coolant; and a plurality of inner manifolds that are formed in position of the cooling plate adjacent to the coolant channels so that the coolant pass through separately from the coolant supply manifold and the coolant return manifold.

According to an aspect of the present invention, the coolant channels may be formed in a central region of a main body of the cooling plate and the inner manifolds may be formed on edges of the main body of the cooling plate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a stack of a fuel cell according to an exemplary embodiment of the present invention; and

FIG. 2 is a perspective view of a flow channel through which a coolant flows in the stack of FIG. 1, according to an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of present invention, by referring to the figures.

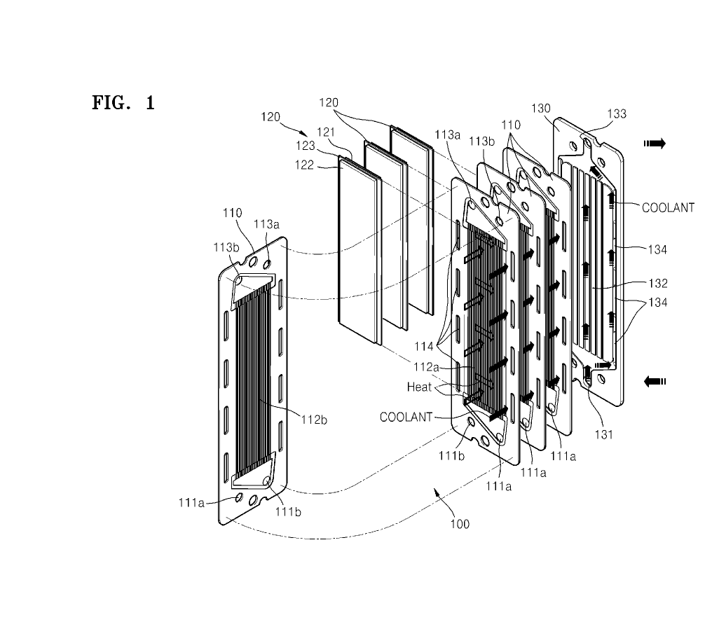

FIG. 1 is an exploded perspective view of a fuel cell stack 50, according to an exemplary embodiment of the present invention. Referring to FIG. 1, the fuel cell stack 50 includes unit cells 100 that are stacked together, and cooling plates 130 that are installed between every five to six unit cells 100. The cooling plates 130 remove heat generated during electricity generation reactions in the unit cells 100.

Each of the unit cells 100 includes membrane electrode assembly 120 (MEA), and two bipolar plates 110 that flank the MEA 120. The MEA includes an anode 121, a cathode 122, and an electrolyte membrane 123 disposed therebetween. The bipolar plates 110 can be included in two different unit cells 100 that are adjacent to one another. Each bipolar plate 110 supplies a fuel and oxygen to the anode 121 and the cathode 122 of adjacent MEAs 120.

Each bipolar plate 110 has fuel channels 112a and oxidant channels 112b formed on opposing sides thereof. The fuel channels 112a supply fuel to the anode 121 and the oxidant channels 112b supply an oxidant (oxygen) to the cathode 123. The fuel channels 112a and the oxidant channels 112b can be collectively referred to as reactant channels.

Each bipolar plate 110 includes a fuel supply manifold 111a, a fuel return manifold 113a, an oxidant supply manifold 111b, and an oxidant return manifold 113b. The fuel supply manifold 111a supplies the fuel to the fuel channels 112a. The fuel return manifold 113a collects fuel that was not consumed by the MEA 10, from the fuel channels 112a. The oxidant supply manifold 111b supplies an oxidant (air and/or oxygen) to the oxidant channels 112b. The oxidant return manifold 113b collects fluids (reaction products and/or oxidants/air) from the oxidant channels.

Each cooling plate 130 includes coolant channels 132, a coolant supply manifold 131, and a coolant return manifold 131. The coolant supply manifold 131 supplies a coolant, such as, water or oil, to the coolant channels 132, where the coolant absorbs heat from the bipolar plate 131. The heated coolant is collected from the coolant channels, by the coolant return manifold 133. The coolant flows from the coolant return manifold 133 to a heat exchanger (not shown), where the coolant is cooled and then returned to the coolant supply manifold. Although not shown, O-rings can be installed around various holes through which fluids flow, to prevent leaks.

Each cooling plate 130 includes coolant channels 144 plurality of inner manifolds 114 and 134 for passing the coolant are formed in the bipolar plate 110 and the cooling plate 130. The inner manifold 114 and 134 forms another flow channel for the coolant so that the coolant can flow through edges of the two bipolar plates 110 and 130 not limitedly flows through the flow channel that passes the coolant supply manifold 131, the coolant channels 132, and the coolant return manifold 133. The inner manifold 114 and 134 is a very effective structure for cooling the reaction heat of the unit cell 100, which will now be described.

If the bipolar plate 110 and the cooling plate 130 have a structure in which the coolant is circulated only through the coolant supply manifold 131, the coolant channels 132, and the coolant return manifold 133 without the inner manifolds 114 and 134, the reaction heat generated from the unit cells 100 is removed in a manner that the reaction heat is transmitted to the cooling plate 130 along a stacking direction of the unit cells 100 as indicated by the arrows of FIG. 1, and then is absorbed by the coolant. However, a thermal conductivity difference between the membrane electrode assembly 120 and the bipolar plate 110 is approximately 100 times. That is, the membrane electrode assembly 120 has a thermal conductivity of, for example, 1.0 W/m.k, and the bipolar plate 110 has that of 100 W/m.k. Thus, heat conduction is smoothly achieved through the bipolar plate 110, however, the heat conduction is not smooth in the membrane electrode assembly 120.

However, in the structure of the unit cell 100, the membrane electrode assembly 120 covers a majority central portion of the bipolar plate 110 and the bipolar plates 110 contact each other only at a portion of edges. Thus, the heat transmission in the stacking direction of the unit cells 100 is largely affected by the membrane electrode assembly 120. That is, due to the membrane electrode assembly 120 that covers a wide region of the bipolar plate 110, the velocity of heat transfer in the stacking direction of the unit cells 100 towards the cooling plate 130 is low, and there is a large temperature difference between the central region of the bipolar plate 110 where the membrane electrode assembly 120 covers and the edge regions of the bipolar plate 110. In this case, cooling efficiency is reduced, and the deformation of the bipolar plate 110 can occur due to severe thermal stress caused by the large temperature difference.

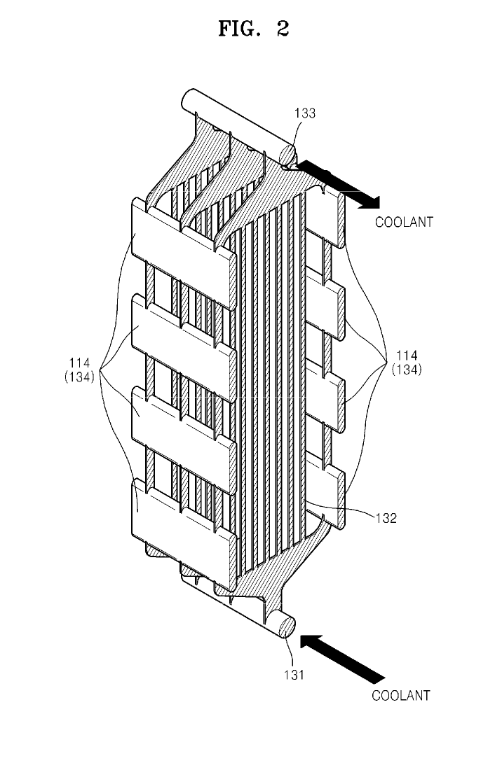

However, if the inner manifolds 114 and 134 are formed in the edge portions of the bipolar plate 110 and the cooling plate 130 to pass the coolant, the reaction heat transmitted in a surface direction (dotted arrows in FIG. 1) in each of the bipolar plates 110 can be rapidly absorbed by the coolant that passes through the inner manifold 114, and thus, cooling can be effectively achieved. That is, besides the reaction heat transmitted in the stacking direction of the unit cells 100, the reaction heat transmitted in a surface direction of each bipolar plate 110 can be rapidly absorbed by the coolant that passes through the inner manifold 114, and thus, cooling speed can be greatly increased. FIG. 2 is a perspective view of a flow channel through which a coolant flows in the stack of FIG. 1, according to an embodiment of the present invention. Referring to FIG. 2, the coolant cools the reaction heat generated from the unit cells 100 while passing through not only the coolant channels 132 of the cooling plate 130 but also the inner manifolds 114 and 134.

This structure is effective in increasing cooling performance of cooling the reaction heat, and also, is effective in temperature increasing performance. That is, when a fuel cell starts up, the coolant is warmed up to an appropriate temperature suitable for operation by passing through the stack after heating the coolant using a heater. At this point, if the bipolar plate 110 includes a flow channel through which the coolant can pass the edges of the bipolar plate 110 through the inner manifolds 114 and 134 in addition to the coolant channels 132, the temperature in the fuel cell can be rapidly increased, and thus, a warming up time of the fuel can be reduced.

A method of operating a fuel cell having the above configuration will now be described. At an initial start up, the coolant is supplied to all flow channels where the coolant passes as depicted in FIG. 1 by heating the coolant using, for example, a heater. Thus, the stack is heated by the heated coolant, and then, the temperature of the stack increases to a temperature suitable for a normal operation. At this point, as described above, since a unit form heating is performed through the coolant channels 132 and the inner manifolds 114 and 134, the temperature of the stack is rapidly increased.

Afterwards, when the temperature of the stack reaches a normal operation temperature, the electricity generation reaction is started by supplying a fuel and oxygen to the anode 212 and the cathode 122 through the flow channels 112a and 112b of the bipolar plate 110. At this point, the coolant that is not heated coolant but room temperature coolant for cooling the reaction heat is circulated in the stack. Thus, in the membrane electrode assembly 120, electricity is generated through a reaction between the fuel supplied to the anode 121 and oxygen in the air supplied to the cathode 122, and reaction heat generated from the unit cells 100 is absorbed by the circulating coolant.

According to the structure described above, a stack structure, in which the cooling of reaction heat can be effectively performed by smoothly performing an electricity generation reaction and the temperature increase at an initial start up can be rapidly achieved, can be realized. The shapes and numbers of the inner manifolds according to the embodiment of the present invention are not limited to the shape and numbers depicted in FIGS. 1 and 2. The shapes of the inner manifolds can be modified in various ways and the number of the inner manifolds can also be increased or decreased as necessary.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A stack of a fuel cell comprising:
a membrane electrode assembly in which an anode, an electricity membrane, and a cathode are stacked;
a bipolar plate having reactant channels through which fluids to be supplied to the anode and the cathode flow and a plurality of inner manifolds that are formed in positions not directly connected to the reactant channels so that a coolant pass through; and
a cooling plate having coolant channels through which a coolant flows and a plurality of inner manifolds that are formed corresponding to the inner manifolds of the bipolar plate so that the coolant pass through.

2. The stack of claim 1, wherein the reactant channel of the bipolar plate and the coolant channels of the cooling plate are respectively formed in central regions of a main body of the bipolar plate and the cooling plate, and the inner manifolds of the bipolar plate and the inner manifolds of the cooling plate respectively are formed on edges of the main body of the bipolar plate and the cooling plate.

3. The stack of claim 1, wherein the membrane electrode assembly contacts the reactant channels, however, does not contact the inner manifolds.

4. The stack of claim 1, wherein the bipolar plate comprises a fuel supply manifold and a fuel return manifold, which are connected to the reactant channels, and the cooling plate comprises a coolant supply manifold and a coolant return manifold, which are connected to the coolant channels.

5. A bipolar plate comprising:
a reactant channels through which fluid flow; and
a plurality of inner manifolds formed in positions of the bipolar plate adjacent to the reactant channels and not to be directly connected to the reactant channels so that the coolant flow through.

6. The bipolar plate of claim 5, wherein the reactant channels are formed in a central region of a main body of the bipolar plate, and the inner manifolds are formed in edges of the bipolar plate.

7. The bipolar plate of claim 5, further comprising a fuel supply manifold and a fuel return manifold, which are directly connected to the reactant channels to constitute a path for entering and leaving fuel.

8. A cooling plate comprising:
coolant channels through which a coolant flows;
a coolant supply manifold and a coolant return manifold which are directly connected to the coolant channels to constitute a path for entering and leaving the coolant; and
a plurality of inner manifolds that are formed in position of the cooling plate adjacent to the coolant channels so that the coolant pass through separately from the coolant supply manifold and the coolant return manifold.

9. The cooling plate of claim 8, wherein the coolant channels are formed in a central region of a main body of the cooling plate and the inner manifolds are formed on edges of the main body of the cooling plate.
